(19) United States
(12) Patent Application Publication
(10) Pub. No.: US 2009/0310526 A1
(43) Pub. Date: Dec. 17, 2009

(54) SYSTEMS AND METHODS OF SIMULTANEOUS, TIME-SHIFTED TRANSMISSION TO MULTIPLE RECEIVERS

(75) Inventors: Dhananjay A. Gore, San Diego, CA (US); Edward H. Teague, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/482,215

(22) Filed: Jun. 10, 2009

Related U.S. Application Data
(60) Provisional application No. 61/060,689, filed on Jun. 11, 2008.

(51) Int. Cl. H04H 20/71

(52) U.S. Cl. 370/312

(57) ABSTRACT

Systems and methods for communicating with multiple receivers simultaneously are disclosed. In one embodiment, the method comprises applying a first adjustment to a first signal based on a first propagation path delay between a transmitter and a first receiver, combining the adjusted first signal and a second signal, and transmitting a composite signal based on the combined signal substantially concurrently to the first receiver and a second receiver.

### RELATED APPLICATIONS

This application claims the benefit of U.S. Provisional Application No. 61/060,689, filed Jun. 11, 2008, the entire content of which is incorporated herein by reference.

### FIELD OF THE INVENTION

The present application relates generally to wireless communications, and more specifically to systems and methods to enable simultaneous, time-shifted transmission to multiple receivers.

### BACKGROUND

Wireless communication systems are widely deployed to provide various types of communication content such as voice, data, and so on. These systems may be multiple-access systems capable of supporting communication with multiple users by sharing the available system resources (e.g., bandwidth and transmit power). Examples of such multiple-access systems include code division multiple access (CDMA) systems, time division multiple access (TDMA) systems, frequency division multiple access (FDMA) systems, 3GPP LTE systems, 3GPP2 UMB systems, and orthogonal frequency division multiple access (OFDMA) systems.

Generally, a wireless multiple-access communication system can simultaneously support communication for multiple wireless terminals. Each terminal communicates with one or more base stations via transmissions on the forward and reverse links. The forward link (or downlink) refers to the communication link from the base stations to the terminals, and the reverse link (or uplink) refers to the communication link from the terminals to the base stations. This communication link may be established via a single-input-single-output (SISO), multiple-input-single-output (MISO), single-input-multiple-output (SIMO), or a multiple-input-multiple-output (MIMO) system.

A MIMO system employs multiple (N_{T}) transmit antennas and multiple (N_{R}) receive antennas for data transmission. A MIMO channel formed by the N_{T} transmit and N_{R} receive antennas may be decomposed into N_{S} independent channels, which are also referred to as spatial channels, where N_{S}≦min{N_{T}, N_{R}}. Each of the N_{S} independent channels corresponds to a dimension. The MIMO system can provide improved performance (e.g., higher throughput and/or greater reliability) if the additional dimensionalities created by the multiple transmit and receive antennas are utilized.

### SUMMARY

The systems, methods, and devices of the invention each have several aspects, no single one of which is solely responsible for its desirable attributes. Without limiting the scope of this invention as expressed by the claims which follow, its more prominent features will now be discussed briefly. After considering this discussion, and particularly after reading the section entitled “Detailed Description of Certain Embodiments” one will understand how the features of this invention provide advantages that include concurrent communication over multiple air interfaces.

One aspect of the disclosure is a method of processing signals for simultaneous transmission to multiple receivers, the method comprising applying a first adjustment to a first signal based on a first propagation path delay between a transmitter and a first receiver, combining the adjusted first signal and a second signal, and transmitting a composite signal based on the combined signal substantially concurrently to the first receiver and a second receiver.

Another aspect of this disclosure is a wireless communication system configured for simultaneous transmission to multiple receivers, the system comprising a phase rotator configured to apply a first phase rotation to a first signal based on a first propagation path delay between a transmitter and a first receiver a summer configured to combine the phase rotated first signal and a second signal, and a transmitter configured to transmit a composite signal based on the combined signal substantially concurrently to the first receiver and a second receiver.

Another aspect of this disclosure is a wireless communication system configured for simultaneous transmission to multiple receivers, the system comprising a first delay unit configured to apply a first time delay to a first signal based on a first propagation path delay between a transmitter and a first receiver, a summer configured to combine the time delayed first signal and a second signal, and a transmitter configured to transmit a composite signal comprising the combined signal substantially concurrently to the first receiver and a second receiver.

Another aspect of this disclosure is a wireless communication system configured for simultaneous transmission to multiple receivers, the system comprising means for applying a first adjustment to a first signal based on a first propagation path delay between a transmitter and a first receiver, means for combining the adjusted first signal and a second signal, and means for transmitting a composite signal based on the combined signal substantially concurrently to the first receiver and a second receiver.

Another aspect of this disclosure is a computer program product comprising computer-readable medium comprising code for causing a computer to apply a first adjustment to a first signal based on a first propagation path delay between a transmitter and a first receiver code for causing a computer to combine the adjusted first signal and a second signal, and code for causing a computer to transmit a composite signal based on the combined signal substantially concurrently to the first receiver and a second receiver.

### BRIEF DESCRIPTION OF THE DRAWINGS

FIG. 1 illustrates a multiple access wireless communication system according to one embodiment.

FIG. 2 is a block diagram of a communication system.

FIG. 3 is a flowchart illustrating an embodiment of a process of determining a propagation path delay between a transmitter and a receiver.

FIG. 4 is a functional block diagram of an embodiment of a signal processor.

FIG. 5 is a flowchart illustrating an embodiment of a process of time adjusting frequency domain signals for transmission to a plurality of receivers.

FIG. 6 is a functional block diagram of another embodiment of a signal processor.

FIG. 7 is a flowchart illustrating an embodiment of a process of time adjusting frequency domain signals for transmission to a plurality of receivers.

### DETAILED DESCRIPTION OF CERTAIN EMBODIMENTS

The word “exemplary” is used herein to mean “serving as an example, instance, or illustration.” Any embodiment described herein as “exemplary” is not necessarily to be construed as preferred or advantageous over other embodiments. The techniques described herein may be used for various wireless communication networks such as Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, etc. The terms “networks” and “systems” are often used interchangeably. A CDMA network may implement a radio technology such as Universal Terrestrial Radio Access (UTRA), cdma2000, etc. UTRA includes Wideband-CDMA (W-CDMA) and Low Chip Rate (LCR). cdma2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDMA, etc. UTRA, E-UTRA, and GSM are part of Universal Mobile Telecommunication System (UMTS). Long Term Evolution (LTE) is an upcoming release of UMTS that uses E-UTRA. UTRA, E-UTRA, GSM, UMTS and LTE are described in documents from an organization named “3rd Generation Partnership Project” (3GPP). cdma2000 is described in documents from an organization named “3rd Generation Partnership Project 2” (3GPP2). These various radio technologies and standards are known in the art.

In the description herein, an access point (AP) (e.g., a base station) may provide communications coverage over a relatively large area or macro area (e.g., a city) or over a relatively small area or femto area (e.g., a residence). The AP may provide an access terminal (AT) (e.g., mobile phone, router, personal computer, etc.) access to a communications network such as, for example, the internet or a cellular network. The teachings herein also may be applicable to APs associated with other types of coverage areas. In various applications, other terminology may be used to reference an access point. For example, an access point may be configured or referred to as an access node, base station, evolved Node B (eNB), Home Node B (HNB), Home eNB, access point base station, and so on. An access point may be a fixed station used for communicating with access terminals (ATs). In some embodiments, an AP may be associated with (e.g., divided into) one or more cells or sectors.

In certain aspects, the present disclosure provides methods and systems to transmit to multiple receivers with different timing adjustments for each receiver. Some embodiments described herein relate to an access terminal (AT) (e.g., a mobile telephone) configured to simultaneously communicate with a plurality of access points (AP) (e.g., base stations). An access terminal (AT) may also be referred to herein as a user equipment (UE), as a mobile station (MS), or as a terminal device. Both an AT and an AP can function as both a transmitter and receiver.

In some networks, it may be necessary for a transmitter to transmit simultaneously to multiple receivers. For example, this may be the case on a reverse link from an AT to an AP when an AT (access terminal) maintains a connection with multiple APs, or when the AT sends different control signaling (e.g., transmission power control signals) to multiple APs. The AT may first generate a composite signal comprising all of the signals to be sent to each of the APs, and then transmit the composite signal. In some cases, it may be necessary for the AT to have different transmission timing adjustments for signals transmitted to each AP such that the signal for each AP is received at a particular time at each AP.

Often, communications from an AT to multiple APs are required to be received at a certain time period at each AP. For example, each AP may have a certain time period or “timing window” during which the AP looks for communications from an AT. Each AP may have its timing window scheduled at the same time as the timing windows of the other APs, or the timing windows may be scheduled at different times. Therefore, each of the signals comprising the composite signal may be time adjusted so that when the composite signal is transmitted, each individual signal is received at each AP during its respective timing window. In the embodiments where each AP has its timing window scheduled at the same time, each individual signal is time adjusted to be received at each AP at the same time.

The propagation paths (i.e., physical path the signal takes) between the AT and each AP may be different. Each propagation path may require a different amount of time (delay) for the signal to physically travel from the AT to the AP. Therefore, transmitting signals at one time to multiple APs from a single AT may result in the signals being received at different times at each AP. Accordingly, in some embodiments described herein communications between an AT and multiple APs may be time adjusted such that the communications are received at the AP within the timing window of each AP.

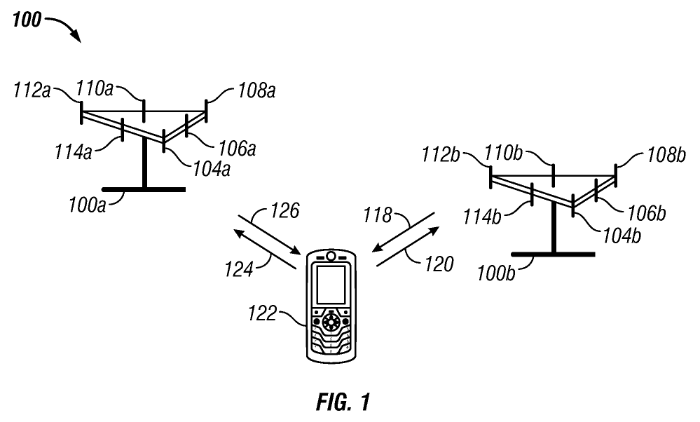

FIG. 1 illustrates a multiple access wireless communication system according to one embodiment. The wireless communication system may comprise one or more access points 100 (AP), such as, for example, APs 101a and 101b. Each access point 100 may comprise multiple antenna groups, one including 104 and 106, another including 108 and 110, and an additional including 112 and 114. In FIG. 1, two antennas are shown for each antenna group, however, more or fewer antennas may be utilized for each antenna group.

The APs may communicate with a plurality of access terminals 122 (ATs). As discussed above, APs may provide access to a communication network (e.g., a cellular network) to ATs. Further, a given AT may communicate with a plurality of APs. For example, AT 122 is in communication with antennas 112b and 114b of AP 100b, where antennas 112b and 114b transmit information to access terminal 122 over forward link 120 and receive information from access terminal 122 over reverse link 118. Access terminal 122 is also in communication with antennas 106a and 108a of AP 100a, where antennas 106a and 108a transmit information to access terminal 122 over forward link 126 and receive information from access terminal 122 over reverse link 124. In a FDD system, communication links 118, 120, 124 and 126 may use different frequencies for communication. For example, forward link 120 may use a different frequency then that used by reverse link 118.

Each group of antennas and/or the geographic area in which they are designed to communicate may be referred to as a sector of the access point. In the embodiment, antenna groups each may be designed to communicate to access terminals in a sector of the areas covered by access point 100.

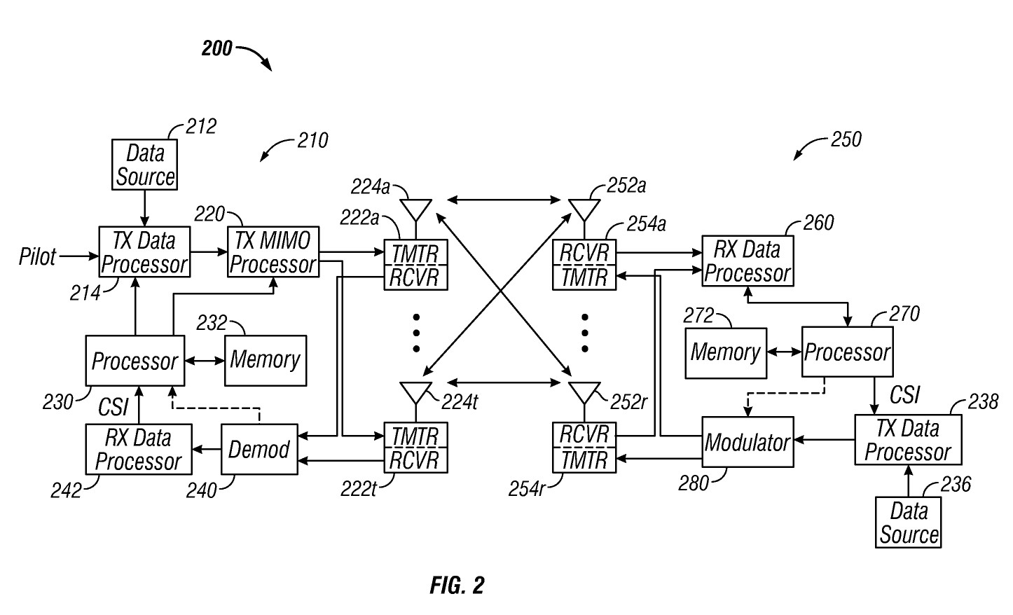

FIG. 2 is a block diagram of an embodiment of a transmitter system 210 (e.g., an AP 100) and a receiver system 250 (e.g., an AT 122) in a MIMO system 200. At the transmitter system 210, traffic data for a number of data streams is provided from a data source 212 to a transmit (TX) data processor 214.

In an embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QSPK, M-PSK, or M-QAM) selected for that data stream to provide modulation symbols. The data rate, coding, and modulation for each data stream may be determined by instructions performed by processor 230. The processor 230 may also be in data communication with a memory 232.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by N_{R} antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{T} “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion. The processor 270 may also be in data communication with a memory 272.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

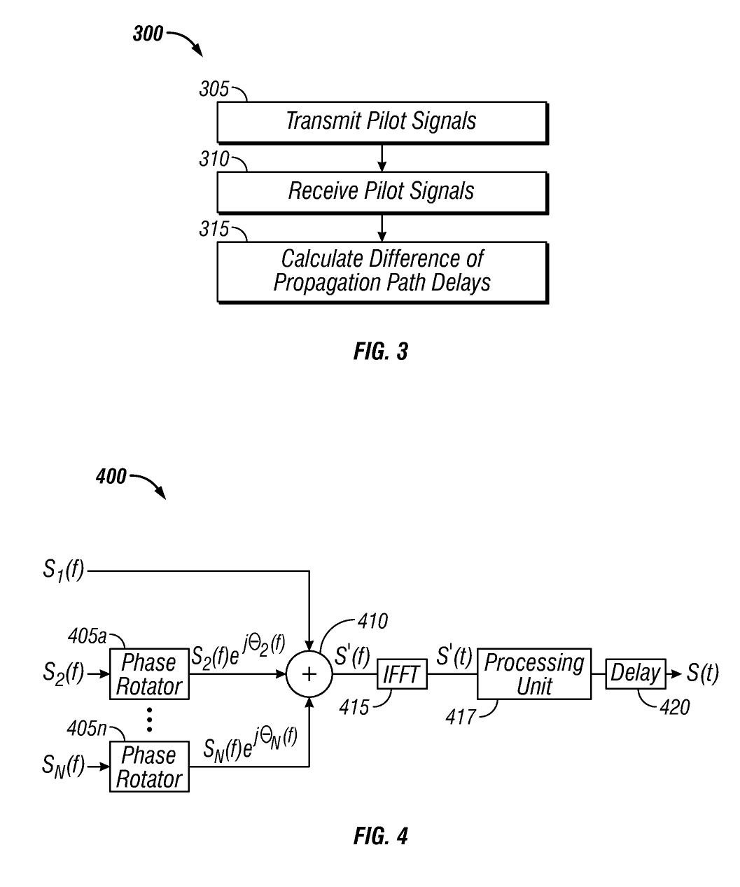

FIG. 3 is a flowchart illustrating an embodiment of a process of determining the difference between a first propagation path delay between a first transmitter system 210a and a receiver system 250 and a second propagation path delay between a second transmitter system 210b and the receiver system 250. The process begins at a step 305, where the transmitter system 210a transmits a first pilot signal and the transmitter system 210b transmits a second pilot signal. In some embodiments, the pilot signals may be transmitted from each transmitter system 210 substantially concurrently (e.g., at the same time). Continuing at a step 310, the receiver system 250 receives the transmitted pilot signals. Further, at a step 315, the receiver system 250 may calculate the difference between the first propagation path delay and the second propagation path delay. The difference may be calculated as the difference between the time the first pilot signal is received and the time the second pilot signal is received. The time the pilot signal is received is known by the receiver system 250. Further, in some embodiments, the receiver system 250 may learn the first propagation path delay and the second propagation path delay directly from the transmitter systems 210. In other embodiments, the receiver system 250 may learn the first propagation path delay and the second propagation path delay from a communication network that connects the transmitter systems 210 and calculates the propagation path delay by methods known in the art.

The difference between the propagation path delays may be used in conjunction with the processes below to time adjust communications.

As described above, some communications over wireless communication systems may require time adjustments. Some such wireless communications systems (e.g., OFDMA and Localized FDMA (LFDMA) systems) use FFT and/or IFFT blocks for transmission processing. The embodiments described herein describe methods of performing time adjustments in the time domain to frequency domain signals.

FIG. 4 is a functional block diagram of an embodiment of a signal processor. Signal processor 400 may correspond to the modulator 280 of FIG. 2 or another suitable component between the path of the modulator 280 and the transceivers 254. Signal processor 400 may comprise one or more phase rotators 405, such as, for example, phase rotators 405a to 405n. The phase rotators 405 may be in data communication with a summer 410. The summer 410 may be in data communication with an IFFT unit 415, which is in data communication with a delay unit 420.

Each of phase rotators 405a to 405n may be configured to apply a phase rotation to a frequency domain signal. For example, each of signals S₁(f) to S_{N}(f) may be a signal in the frequency domain to be transmitted to different receivers (e.g., APs). As shown, signal S₂(f) is input into phase rotator 405a. Phase rotator 405a may apply a first phase rotation Θ₂(f) to signal S₂(f) resulting in a phase rotated frequency domain signal S₂(f)e^{jΘ}^{₂}^{(f)}. It should be noted that the first phase rotation Θ₂(f) is a function of f. Similar phase rotations may be applied to one or more of the additional signals S₁(f) to S_{N}(f). Each of these additional phase rotations may be a different function of f.

Summer 410 may be configured to sum together separate signals in the frequency domain resulting in a composite frequency domain signal. For example, each of the signals S₁(f) to S_{N}(f) or their phase rotated counterpart may be summed together at summer 410 resulting in a composite frequency domain signal S′(f).

IFFT unit 415 may be configured to apply an inverse fast Fourier transform (IFFT) to a signal in the frequency domain, resulting in a corresponding time-domain signal. For example, composite frequency domain signal S′(f) may be input into IFFT unit 415. IFFT unit 415 may then output a corresponding time domain signal S′(t). It will be appreciated by one of ordinary skill in the art that IFFT unit 415 may be replaced with a suitable unit configured to perform an inverse Fourier transform.

In some embodiments, a processing unit 417 may be positioned between the IFFT unit 415 and the delay unit 420. The processing unit 417 may be configured to perform additional signal processing on the time domain signal S′(t), such as, for example, windowing and/or cyclic prefix insertion.

Delay unit 420 may be configured to apply a time delay Δ (e.g., 1 second) to a signal in the time domain. For example, delay unit 420 may apply a time delay Δ to signal S′(t) resulting in an output signal S′(t−Δ) (i.e., S(t)).

Phase rotation of a frequency domain signal, followed by application of an IFFT to the phase rotated signal, results in an approximately time adjusted time-domain signal of the original frequency domain signal as described below. For example, a phase rotation and IFFT can be used to approximately generate a signal S₂(t−Δ₂) corresponding to a time adjusted signal S₂(t) with a time adjustment of Δ₂. The example is described with respect to frequency domain signal S₂(f), which may correspond to time-domain signal S₂(t). Accordingly, applying a fast Fourier transform (FFT) to S₂(t) results in signal S₂(f) and applying an IFFT to signal S₂(f) results in signal S₂(t).

Applying a phase rotation Θ₂(f) to signal S₂(f) results in signal S₂(f)e^{jΘ}^{₂}^{(f)}. Applying an IFFT to S₂(f)e^{jΘ}^{₂}^{(f)} results in approximately S₂(t−Δ₂). The function Θ₂(f) may be chosen to result in a particular value for Δ₂. Accordingly, a phase rotation in the frequency domain as determined by Θ₂(f) corresponds approximately to a time adjustment of Θ₂ in the time domain. The generated signal, is an approximation of S₂(t−Δ₂) as a phase rotation leads to a circular delay of the signal S₂(t) as opposed to a linear delay. However, the degradation of the signal may be minimal such as when Δ₂ is a small value.

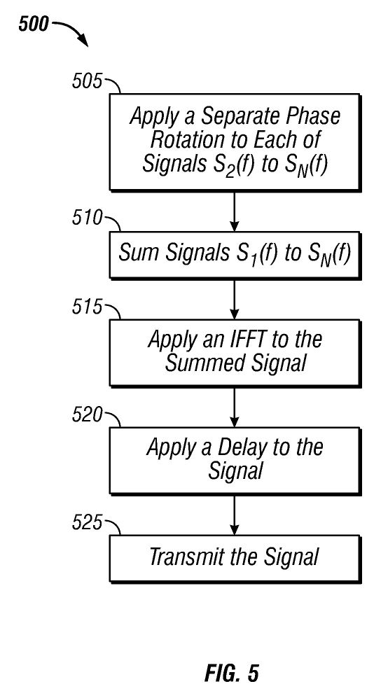

When transmitting to multiple receivers, each propagation path delay from the transmitter to each receiver may be an order of magnitude larger than the differences between the propagation path delays. For example, the propagation path delay between AT and AP₁ may be Δ₁ and the propagation path delay between AT and AP₂ may be Δ₂. In this example, Δ₁>>|Δ₂−Δ₁| and Δ₂>>|Δ₂−Δ₁|. A transmitter may transmit signal S₁(f) to AP₁ and S₂(f) to AP₂. Applying a phase rotation in the frequency domain corresponding to a time adjustment of Δ₂ in the time domain to signal S₂(f) may result in unacceptable signal degradation. Accordingly, in some embodiments, a phase rotation corresponding to the difference (Δ₂−Δ₁) is applied to the frequency domain signal S₂(f). Signals S₁(f) and S₂(f) may then be summed and transformed to the time domain. A time delay Δ₁ is applied to the corresponding summed time domain signal, resulting in a signal that comprises time adjusted signal S₁(t−Δ₁) and an approximation of time adjusted signal S₂(t−Δ₂). The smaller phase rotation applied to signal S₂(f) may not result in unacceptable signal degradation. The process is described in detail below with respect to FIG. 5.

FIG. 5 is a flowchart illustrating an embodiment of a process of time adjusting frequency domain signals for transmission to a plurality of receivers. In some embodiments, the steps of process 500 may be performed by signal processor 400. Process 500 begins at a step 505, where phase rotations Θ₂(f) to Θ_{N}(f) are applied to each of signals S₂(f) to S_{N}(f), respectively. Each of signals S₁(f) to S_{N}(f) may be a signal in the frequency domain to be transmitted to a particular receiver (e.g., AP₁ to AP_{N}). For example, signals S₁(f) to S_{N}(f) may each be transmitted to different APs from an AT. Further, at a step 510, S₁(f) and the phase rotated signals S₂(f) to S_{N}(f) may be summed together resulting in a composite frequency domain signal S′(f).

Continuing at a step 515, an IFFT may be applied to the composite signal S′(f) resulting in a time domain signal S′(t). The time domain signal S′(t) may correspond to the sum of S₁(t) (i.e., the corresponding time domain signal to S₁(f)) and the time adjusted signals S₂(t−Δ₂′) to S_{N}(t−Δ_{N}′) (i.e., the corresponding time domain signals to the phase rotated signals S₂(f) to S_{N}(f)). At a next step 520, a time delay Δ may be applied to signal S′(t), resulting in signal S(t).

In some embodiments, each of Δ₁ to Δ_{N} may correspond to the propagation path delay between the AT and each of AP₁ to AP_{N}. In other embodiments, each of Δ₁ to Δ_{N} may be set such that each signal S₁(t) to S_{N}(t) arrive at the destined receiver (e.g., AP₁ to AP_{N}) within the timing window of the receiver. Further, Δ may be set to Δ₁. Δ₂′ to Δ_{N}′ may be set to (Δ₂−Δ) to (Δ_{N}−Δ), respectively. Accordingly, signal S(t) may correspond to the sum of S₁(t−Δ₁) to S_{N}(t−ΔN).

Continuing at a step 525, the transmitter transmits the signal S(t). The signal S(t) may be received by one or more receivers, such as, for example, AP₁ to AP_{N}. In some embodiments, the portion of the signal destined for each particular receiver arrives at the same time at each receiver due to the applied delay. In other embodiments, the portion of the signal destined for each particular receiver arrives during the timing window of each particular receiver.

Accordingly, the process 500 may beneficially allow an AT such as transmitter system 210 to communicate simultaneously with multiple APs receivers such as receiver system 250. Further, process 500 requires use of only a single IFFT to process signals for transmission. This may reduce the cost manufacturing the transmitter system 210 and may also reduce the power consumption of the transmitter system 210. This is because the circuitry for performing an IFFT may require additional chip space to implement the IFFT costing extra money. Further, running the additional circuitry may require additional power consumption.

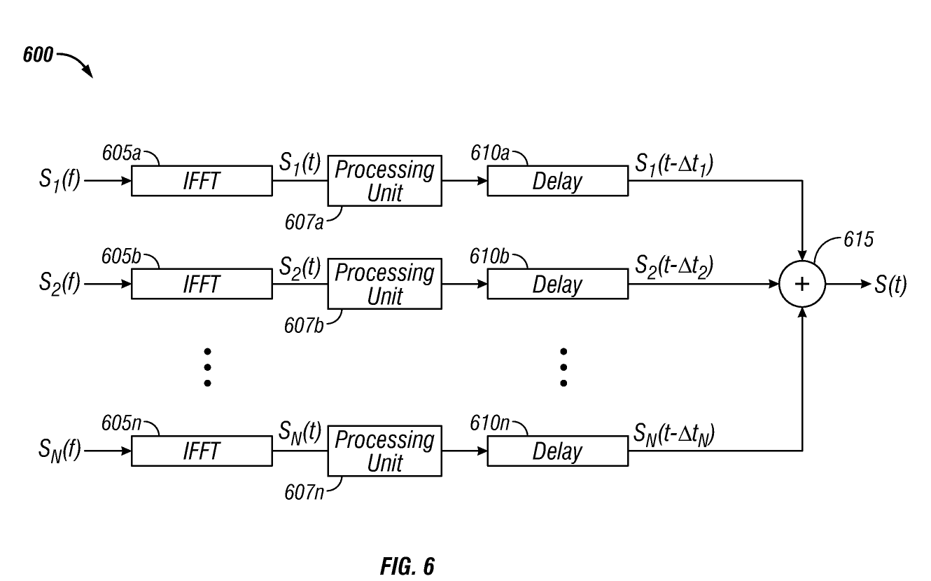

FIG. 6 is a functional block diagram of another embodiment of a signal processor. Signal processor 600 may correspond to the modulator 280 of FIG. 2 or another suitable component between the path of the modulator 280 and the transceivers 254. Signal processor 600 may comprise one or more IFFT units 605, such as, for example, IFFT units 605a to 605n. Each IFFT unit 605 may be in data communication with a delay unit 610. For example, the IFFT units 605a to 605n each may be in data communication with delay units 610a to 610n, respectively. Each of the delay units 610 may be in data communication with a summer 615.

IFFT unit 605 may be configured to apply an inverse fast Fourier transform (IFFT) to a signal in the frequency domain, resulting in a corresponding time-domain signal. For example, each of frequency domain signals S₁(f) to S_{N}(f) may be input into an IFFT unit 605. Each IFFT unit 605 may then output a corresponding time domain signal, such as, for example signals S₁(t) to S_{N}(t). It will be appreciated by one of ordinary skill in the art that IFFT unit 605 may be replaced with a suitable unit configured to perform an inversed Fourier transform.

In some embodiments, a processing unit may 607 be positioned between each IFFT unit 605 and each delay unit 610. The processing units 607a-607n may be configured to perform additional signal processing on the time domain signals S₁(t) to S_{N}(t), such as, for example, windowing and/or cyclic prefix insertion.

Delay unit 610 may be configured to apply a time delay Δ (e.g., 1 microsecond) to a signal in the time domain. For example, delay units 605a to 605n may apply time delays Δ₁ to Δ_{N} to signals S₁(t) to S₂(t), respectively, resulting in time adjusted signals S₁(t−Δ₁) to S₂(t−Δ_{N}).

Summer 615 may be configured to sum together separate signals in the time domain resulting in a composite time domain signal. For example, each of the signals S₁(t−Δ₁) to S₂(t−Δ_{N}) may be summed together at summer 615 resulting in a composite time domain signal S(t).

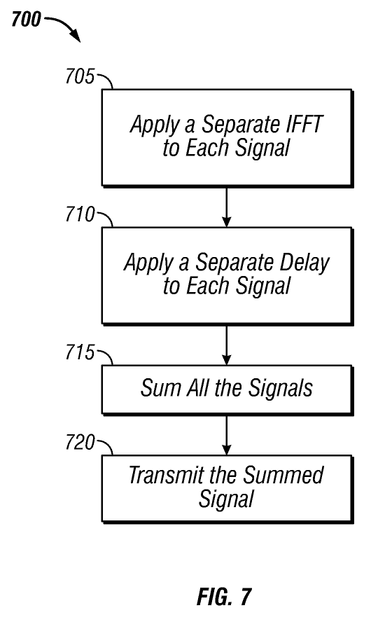

FIG. 7 is a flowchart illustrating an embodiment of a process of time adjusting frequency domain signals for transmission to a plurality of receivers. In some embodiments, the steps of process 700 may be performed by signal processor 600. Beginning at a step 705, a separate IFFT may be applied to applied to each of signals S₂(f) to S_{N}(f) resulting in time domain signals S₁(t) to S_{N}(t). Each of signals S₁(f) to S_{N}(f) may be a signal in the frequency domain to be transmitted to a particular receiver (e.g., AP₁ to AP_{N}). For example, signals S₁(f) to S_{N}(f) may each be transmitted to different APs from an AT.

Continuing at a step 710, a delay Δ₁ to Δ_{N} is applied to each of S₁(t) to S_{N}(t), respectively, resulting in S₁(t−Δ₁) to S_{N}(t−Δ_{N}). In some embodiments, each of Δ₁ to Δ_{N} may correspond to the propagation path delay between AT and each of AP₁ to AP_{N}. In other embodiments, each of Δ₁ to Δ_{N} may be set such that each signal S₁(t) to S_{N}(t) arrive at the destined receiver (e.g., AP₁ to AP_{N}) within the timing window of the receiver.

Next, at a step 715, each of signals S₁(t−Δ₁) to S_{N}(t−Δ_{N}) are summed together resulting in composite signal S(t). Further, at a step 720, the transmitter transmits the signal S(t). The signal S(t) may be received by one or more receivers, such as, for example, AP₁ to AP_{N}. In some embodiments, the portion of the signal destined for each particular receiver arrives at the same time at each receiver due to the applied delay. In other embodiments, the portion of the signal destined for each particular receiver arrives during the timing window of each particular receiver.

Accordingly, the process 700 may beneficially allow an AT such as transmitter system 210 to communicate simultaneously with multiple APs receivers such as receiver system 250. Process 700 in contrast to process 500 requires use of multiple IFFTs to process signals for transmission. This may increase the cost manufacturing the transmitter system 210 and may also increase the power consumption of the transmitter system 210 as discussed above with respect to FIG. 5. However, it may lead to less signal degradation as discussed with respect to FIG. 4.

While the above processes 300, 500, and 700 are described in the detailed description as including certain steps and are described in a particular order, it should be recognized that these processes may include additional steps or may omit some of the steps described. Further, each of the steps of the processes does not necessarily need to be performed in the order it is described.

Even though an explicit scenario is used in the above discussion to explain the disclosure, the procedure is applicable to any scenario that may require multiple signals to be transmitted to different receivers with variable timing shifts.

It is understood that the specific order or hierarchy of steps in the processes disclosed is an example of exemplary approaches. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

What is claimed is:

1. A method of processing signals for simultaneous transmission to multiple receivers, the method comprising:
applying a first adjustment to a first signal based on a first propagation path delay between a transmitter and a first receiver;
combining the adjusted first signal and a second signal; and
transmitting a composite signal based on the combined signal substantially concurrently to the first receiver and a second receiver.

2. The method of claim 1, further comprising:
applying an inverse fourier transform to the combined signal to obtain a combined time-domain signal; and
applying a first time delay to the combined time-domain signal to obtain the composite signal,
wherein the first signal comprises a first frequency domain signal, wherein applying the first adjustment to the first signal comprises applying a first phase rotation to the first signal, and wherein the second signal comprises a second frequency domain signal.

3. The method of claim 2, wherein the first time delay is based on a second propagation path delay between the transmitter and the second receiver.

4. The method of claim 1, further comprising:
applying a first inverse fourier transform to a first frequency domain signal to obtain the first signal;
applying a second inverse fourier transform to a second frequency domain signal to obtain an unadjusted second signal; and
applying a second delay to the unadjusted second signal to obtain the second signal,
wherein applying the first adjustment to the first signal comprises applying a first delay to the first signal, and wherein the composite signal comprises the combined signal.

5. The method of claim 4, wherein the second delay is based on a second propagation path delay between the transmitter and the second receiver.

6. The method of claim 1, wherein the composite signal comprises a first portion and a second portion, and wherein the first receiver receives the first portion within a first desired window and the second receiver receives the second portion within a second desired window.

7. The method of claim 1, wherein transmitting the composite signal comprises transmitting the composite signal using at least one of an orthogonal frequency division multiple access protocol, a localized frequency division multiple access protocol, and a code division multiple access protocol.

8. A wireless communication system configured for simultaneous transmission to multiple receivers, the system comprising:
a phase rotator configured to apply a first phase rotation to a first signal based on a first propagation path delay between a transmitter and a first receiver;
a summer configured to combine the phase rotated first signal and a second signal; and
a transmitter configured to transmit a composite signal based on the combined signal substantially concurrently to the first receiver and a second receiver.

9. The system of claim 8, further comprising:
a transform unit configured to apply an inverse fourier transform to the combined signal to obtain a combined time-domain signal; and
a delay unit configured to apply a first time delay to the combined time-domain signal to obtain the composite signal,
wherein the first signal comprises a first frequency domain signal and the second signal comprises a second frequency domain signal.

10. The system of claim 9, wherein the first time delay is based on a second propagation path delay between the transmitter and the second receiver.

11. The system of claim 8, wherein the composite signal comprises a first portion and a second portion, and wherein the first receiver receives the first portion within a first desired window and the second receiver receives the second portion within a second desired window.

12. The system of claim 8, wherein the transmitter is further configured to transmit the composite signal using at least one of an orthogonal frequency division multiple access protocol, a localized frequency division multiple access protocol, and a code division multiple access protocol.

13. A wireless communication system configured for simultaneous transmission to multiple receivers, the system comprising:
a first delay unit configured to apply a first time delay to a first signal based on a first propagation path delay between a transmitter and a first receiver;
a summer configured to combine the time delayed first signal and a second signal; and
a transmitter configured to transmit a composite signal comprising the combined signal substantially concurrently to the first receiver and a second receiver.

14. The system of claim 13, further comprising:
a first transform unit configured to apply a first inverse fourier transform to a first frequency domain signal to obtain the first signal;
a second transform unit configured to apply a second inverse fourier transform to a second frequency domain signal to obtain an unadjusted second signal; and
a second delay unit configured to apply a second delay to the unadjusted second signal to obtain the second signal.

15. The system of claim 14, wherein the second delay is based on a second propagation path delay between the transmitter and the second receiver.

16. The system of claim 13, wherein the composite signal comprises a first portion and a second portion, and wherein the first receiver receives the first portion within a first desired window and the second receiver receives the second portion within a second desired window.

17. The system of claim 13, wherein the transmitter is further configured to transmit the composite signal using at least one of an orthogonal frequency division multiple access protocol, a localized frequency division multiple access protocol, and a code division multiple access protocol.

18. A wireless communication system configured for simultaneous transmission to multiple receivers, the system comprising:
means for applying a first adjustment to a first signal based on a first propagation path delay between a transmitter and a first receiver;
means for combining the adjusted first signal and a second signal; and
means for transmitting a composite signal based on the combined signal substantially concurrently to the first receiver and a second receiver.

19. The system of claim 18, wherein the applying means comprises a phase rotator.

20. The system of claim 18, wherein the applying means comprises a delay unit.

21. The system of claim 18, wherein the combining means comprises a summer and the transmitting means comprises a transmitter.

22. A computer program product comprising:
computer-readable medium comprising:
code for causing a computer to apply a first adjustment to a first signal based on a first propagation path delay between a transmitter and a first receiver;
code for causing a computer to combine the adjusted first signal and a second signal; and
code for causing a computer to transmit a composite signal based on the combined signal substantially concurrently to the first receiver and a second receiver.
